(19) United States
(12) Patent Application Publication
(10) Pub. No.: US 2024/0106054 A1
(43) Pub. Date: Mar. 28, 2024

(54) BATTERY MODULE MOUNTING STRUCTURE FOR A VEHICLE

(71) Applicants: HYUNDAI MOTOR COMPANY, Seoul (KR); KIA CORPORATION, Seoul (KR)

(72) Inventor: Jun Young Lim, Seoul (KR)

(73) Assignees: HYUNDAI MOTOR COMPANY, Seoul (KR); KIA CORPORATION, Seoul (KR)

(21) Appl. No.: 18/136,460

(22) Filed: Apr. 19, 2023

(30) Foreign Application Priority Data
Sep. 22, 2022 (KR) 10-2022-0120051

(51) Int. Cl. H01M 50/249; H01M 10/6565; H01M 10/6566; H01M 50/186; H01M 50/244

(52) U.S. Cl. CPC H01M 50/249; H01M 10/6565; H01M 10/6566; H01M 50/186; H01M 50/244; H01M 2220/20

(57) ABSTRACT

Disclosed is a battery module mounting structure for a vehicle. In particular, the battery module mounting structure includes: a first case configured to surround one side of a battery module; a second case coupled to the first case and configured to surround the other side of the battery module so that the battery module is accommodated in an inner space defined by the first case; and a mounting plate positioned between the battery module and the first case, coupled to the first case, and to which the battery module is fixed.

### CROSS REFERENCE TO RELATED APPLICATION

The present application claims priority to Korean Patent Application No. 10-2022-0120051, filed on Sep. 22, 2022, the entire contents of which are incorporated herein by reference.

### BACKGROUND

### Field

The present disclosure relates to a mounting structure for a battery module of a vehicle.

### Description of the Related Art

In order to supply electric power required for an electric vehicle or a hybrid vehicle, a battery module including a plurality of battery cells is usually mounted in the electric vehicle or hybrid vehicle.

The battery module as described above is often mounted in the vehicle or mounted on the lower side of the vehicle. When the battery module is mounted on the lower side of the vehicle, a case surrounds the outside of the battery module to prevent foreign substances or moisture from penetrating into the battery module from the outside.

In addition, the battery module described above requires proper cooling.

The foregoing explained as the background of the technology is intended merely to aid in the understanding of the background of the present disclosure, and is not intended to mean that the present disclosure falls within the purview of the related art that is already known to those having ordinary skill in the art.

### SUMMARY OF THE DISCLOSURE

The present disclosure provides a battery module mounting structure for a vehicle that enables a battery module to be mounted so as to be located outside the lower side of a vehicle, and can provide stable mountability and watertightness of the battery module with a simple configuration and achieve excellent cooling performance of the battery module.

The technical objects to be achieved by the present disclosure are not limited to the above-mentioned technical objects, and the other technical objects not mentioned may be clearly understood by those having ordinary skill in the art from the present disclosure.

According to an embodiment of the present disclosure, a battery module mounting structure for a vehicle includes: a first case configured to surround one side of a battery module; a second case coupled to the first case and configured to surround the other side of the battery module so that the battery module is accommodated in an inner space defined by the first case and the second case; and a mounting plate positioned between the battery module and the first case and coupled to the first case. In particular, the battery module is fixed to the mounting plate.

The mounting plate may surround a projection surface of the battery module vertically projected on the first case.

A plurality of mounting bolts for fixing the battery module may be disposed on the mounting plate and protrude toward the battery module.

The mounting plate may be bent to form a flow path of air passing through the battery module between the mounting plate and the battery module.

The mounting plate may include a flow path forming part bent to be spaced apart from the battery module and configured to form the flow path between the mounting plate and the battery module, and the flow path forming part may be fixed to the first case.

The mounting plate may have a portion disposed on the upper side of the flow path forming part, spaced apart upwardly from the first case, and configured to support the battery module, and in the portion of the mounting plate spaced apart upwardly from the first case, the mounting bolts may pass through only the mounting plate and battery module.

The flow path forming part of the mounting plate may be elongated and configured to form the flow path along a direction in which battery cells of the battery module are stacked on one another, one side of the flow path may be sealed by a side panel provided in the battery module, and the other side of the flow path may be connected to a blower through a blower duct.

A module duct may be disposed on the other side of the battery module and configured to distribute the air introduced into an air inlet to the battery cells that constitute the battery module.

Sealing members may be disposed on both sides of the flow path forming part of the mounting plate that are in contact with the battery module, and a portion thereof that is in contact with the side panel of the battery module, and configured to secure airtightness of the flow path.

The flow path forming part may be provided in the center of the mounting plate, and one side of the flow path forming part may be bent in the same direction as a wall surface of the first case and fixed in a state of closely contacting the wall surface of the first case.

A battery module mounting structure for a vehicle according to an embodiment of the present disclosure includes: a battery module including a plurality of battery cells stacked in a row; a first case disposed on one side of the battery module and configured to accommodate the battery module; and a mounting plate configured to fix the battery module to the first case while surrounding a surface facing the battery module toward the first case.

A module duct having an air inlet may be provided on the other side of the battery module, and a flow path through which air introduced into the air inlet and passed between the battery cells through the module duct flows may be formed between the mounting plate and the battery module.

The flow path may be elongated along a battery cell stacking direction of the battery module, and the mounting plate may include a flow path forming part bent and configured to form a space that defines the flow path between the mounting plate and the battery module.

One side of the flow path may be sealed by a side panel protruding to one side of the battery module, and the other side of the flow path may be connected to a blower through a blower duct.

Sealing members may be disposed between the battery module and the mounting plate and secure airtightness of the flow path by pressure at which the battery module is fastened to the mounting plate.

The sealing members may be disposed, in a state of being connected to each other, on both sides of the flow path forming part of the mounting plate that are in contact with the battery module, and at a portion thereof that is in contact with the side panel of the battery module.

In a cross section perpendicular to the battery cell stacking direction of the battery module, a central portion of the mounting plate may protrude toward the first case by the flow path forming part and be coupled to the first case, and one side of the mounting plate based on the flow path forming part may be bent in the same direction as a wall surface of the first case and fixed in a state of closely contacting the wall surface of the first case.

A second case may be coupled to the other side of the battery module, the second case being coupled to the first case, configured to accommodate the battery module therein, and through which an air inlet of the module duct and an air outlet of the blower are formed.

The battery module mounting structure according to the present disclosure enables a battery module to be mounted so as to be located outside the lower side of a vehicle, and can provide stable mountability and watertightness of the battery module with a simple configuration and achieve excellent cooling performance of the battery module.

### BRIEF DESCRIPTION OF THE DRAWINGS

FIG. 1 is a view illustrating a battery module mounting structure for a vehicle according to an embodiment of the present disclosure.

FIG. 2 is a view illustrating a state in which a first case and a battery module in FIG. 1 are separated from each other.

FIG. 3 is a cross-sectional view taken along line III-III of FIG. 1.

FIG. 4 is a view illustrating a state in which a blower is further mounted in the battery module mounting structure of FIG. 1.

FIG. 5 is a cross-sectional view taken along line V-V of FIG. 4.

FIG. 6 is a cross-sectional view taken along line VI-VI of FIG. 4.

### DETAILED DESCRIPTION OF THE DISCLOSURE

Hereinafter, embodiments of the present disclosure are described in detail with reference to the accompanying drawings. However, regardless of the reference character, the same or similar constituent elements shall be given the same reference number and the redundant descriptions thereof have been omitted.

The suffix “module” and “unit” for the constituent elements used in the description below are given or mixed in consideration of only the ease of writing the specification, and do not have any distinctive meaning or role in itself each other.

In describing the embodiments of the present disclosure, when a specific description of related publicly known technology is deemed to obscure the subject matter disclosed in the present disclosure, the detailed description has been omitted. Furthermore, the accompanying drawings are intended to facilitate the understanding of the embodiments set forth in the present disclosure, and the technical idea disclosed in the present disclosure is not limited by the accompanying drawings. All alterations, equivalents, and substitutes that are included within the technical idea and scope of the present disclosure should be understood as falling within the scope of the present disclosure.

The ordinal number terms such as first, second, and so on may be used to describe various constituent elements but do not limit these constituent elements. These terms are only used to distinguish one constituent element from another element.

It should be understood that a constituent element, when referred to as being “connected to” or “coupled to” another constituent element, may be directly connected or directly coupled to another constituent element or may be coupled or connected to another constituent element with a third constituent element disposed therebetween. In contrast, it should be understood that a constituent element, when referred to as being “directly coupled to” or “directly connected to” another constituent element, is coupled or connected to another constituent element without a third constituent element therebetween.

A noun in singular form has the same meaning as nouns when used in plural form, unless it has a different meaning in context.

It should be understood that, throughout the present specification, the term “include”, “have” or the like is intended to indicate that a feature, a number, a step, an operation, a constituent element, a component, or a combination thereof is present, without precluding the possibility that one or more other features, numbers, steps, operations, constituent elements, components, or a combination thereof will be present or added.

When a component, device, element, or the like of the present disclosure is described as having a purpose or performing an operation, function, or the like, the component, device, or element should be considered herein as being “configured to” meet that purpose or to perform that operation or function.

In addition, a unit or a control unit included in names such as a motor control unit (MCU) and a hybrid control unit (HCU) is merely a term widely used for naming a controller that controls a specific function of a vehicle, and does not mean a generic function unit.

The controller may include a communication device that communicates with other controllers or sensors to control a function in charge, a memory that stores an operating system or logic command and input/output information, and one or more processors that performs judgment, operation, and decision necessary for controlling the function in charge.

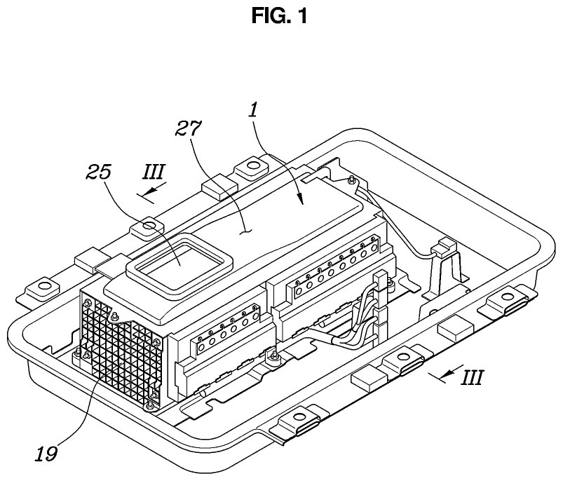

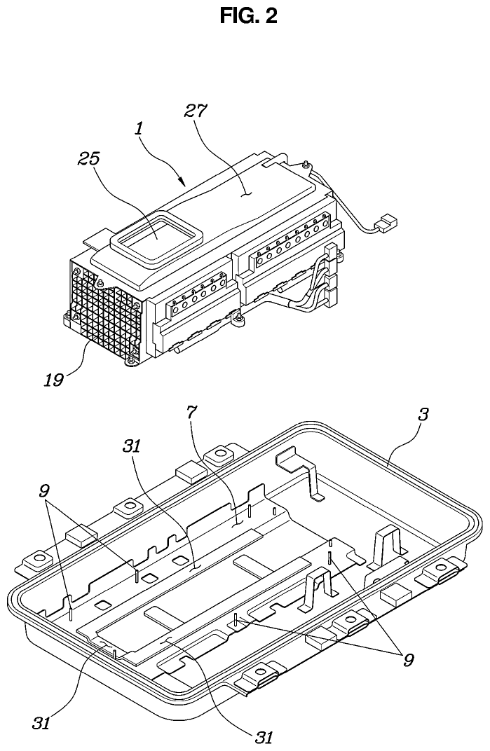

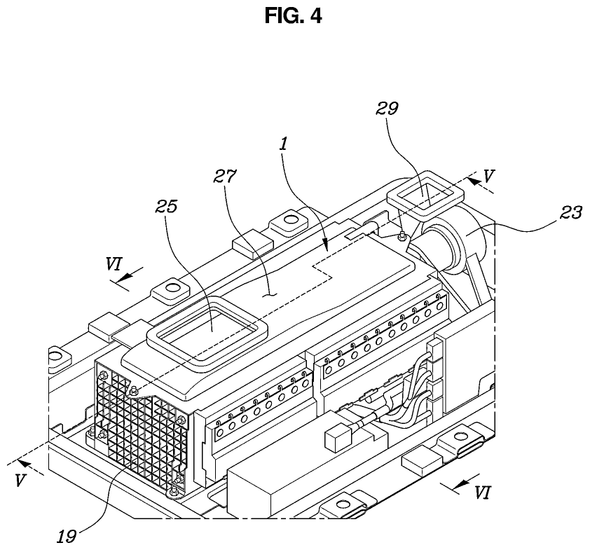

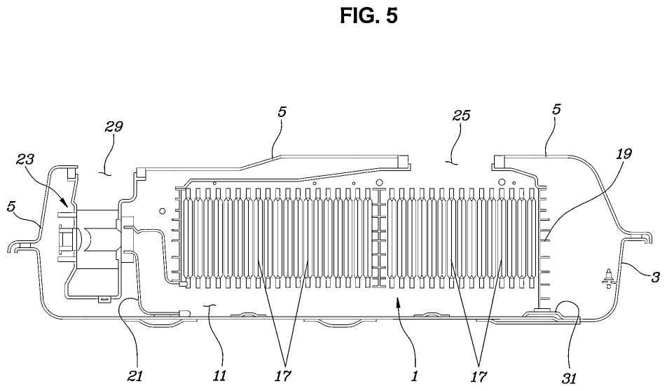

Referring to FIGS. 1 to 6, a battery module mounting structure for a vehicle according to the present disclosure includes: a first case 3 disposed to surround one side of a battery module 1; a second case 5 coupled to the first case 3 and configured to surround the other side of the battery module 1 so that the battery module 1 is accommodated in an inner space formed by the first case 3 and the second case 5 together; and a mounting plate 7 positioned between the battery module 1 and the first case 3 and coupled to the first case 3. the battery module 1 is fixed to the mounting plate 7.

In other words, in the battery module mounting structure of the present disclosure, the battery module 1 is accommodated in the inner space formed by the first case 3 and the second case 5, and the mounting plate 7 is provided between the first case 3 and the battery module 1 so that the battery module 1 is fixed to the first case 3 through the mounting plate 7.

Because the battery module 1 is surrounded by the first case 3 and the second case 5, moisture or foreign substances from the outside are prevented from passing through the first case 3 and the second case 5 and penetrating into the battery module 1, even when the battery module 1 is disposed outside of the lower side of the vehicle, thereby securing watertightness of the battery module 1.

Unlike the above embodiment, if the battery module 1 is directly fixed to the first case 3, bolts for fixing the battery module 1 have to be directly welded to the first case 3. Then, a watertightness of the battery module with respect to the first case is deteriorated due to fatigue failure of a welding part. However, when the battery module 1 is fixed to the first case 3 through the mounting plate 7 as in the present disclosure, as described later, mounting bolts 9 for fixing the battery module 1 are provided on the mounting plate 7, such that the deterioration of watertightness between the battery module 1 and the first case 3 is structurally prevented or significantly reduced, and thus more stable watertightness is provided.

In one embodiment, the mounting plate 7 may surround a projection surface of the battery module 1 which is vertically projected toward the first case 3.

Because the mounting plate 7 itself is coupled to the first case 3 to make the battery module 1 to be fixed to the first case 3 in a state in which the mounting plate 7 firmly fixes one side of the battery module 1, the mounting plate 7 may have a size sufficient to cover the whole of one side of the battery module 1 and should be installed at a position corresponding to the side to be covered.

In another embodiment, a flow path 11 through which air cooling the battery module 1 flows is formed between the battery module 1 and the mounting plate 7. In order to form the flow path 11, the mounting plate 7 may be installed at a position and have a size to cover the whole of one side of the battery module 1.

A plurality of mounting bolts 9 for fixing the battery module 1 are provided on the mounting plate 7 to protrude toward the battery module 1.

Accordingly, when nuts 13 are fastened to the mounting bolts 9 in a state where the battery module 1 is seated on the upper side of the mounting plate 7 so that the mounting bolts 9 are inserted into the battery module 1, the battery module 1 may be easily fixed to the mounting plate 7.

The mounting plate 7 has a bent shape to form the flow path 11 of air passing through the battery module 1 between the mounting plate 7 and the battery module 1.

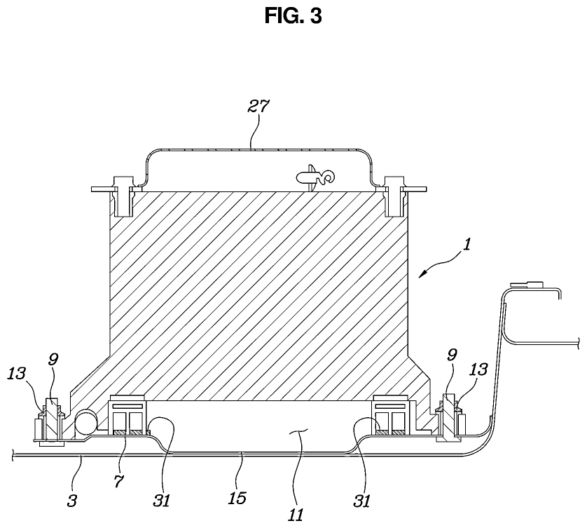

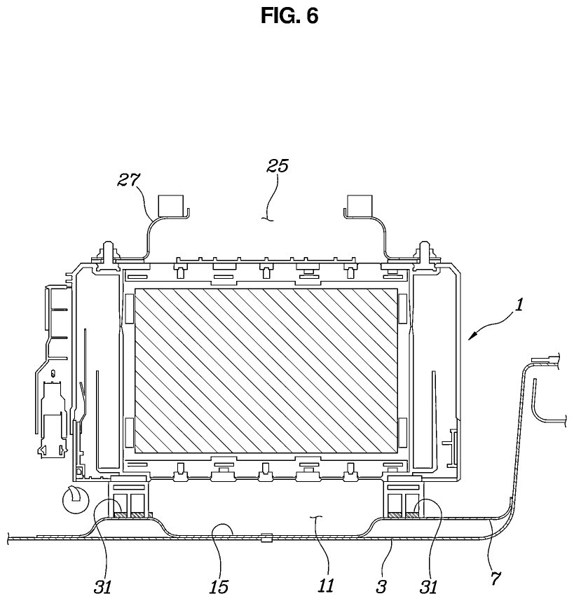

In other words, the mounting plate 7 includes a flow path forming part 15 which is bent and spaced apart from the battery module 1. The flow path forming part 15 is configured to form the flow path 11 between the mounting plate 7 and the battery module 1 as illustrated in FIGS. 3 and 6, and the flow path forming part is fixed to the first case 3.

The mounting plate 7 and the first case 3 may be coupled by means of an adhesive or welding.

When the mounting plate 7 is coupled to the first case 3 by welding, a contact area between the mounting plate 7 and the first case 3 is significantly larger than when the bolts are used. Therefore, welding is performed in such a way that a plurality of welding points are formed between the mounting plate 7 and the first case 3 so that there is no concern about deterioration of watertightness due to fatigue failure of a welding part, which improves durability compared to the related art in which bolts are welded to the first case 3.

The flow path forming part 15 of the mounting plate 7 is elongated and configured to form the flow path 11 along a direction in which battery cells 17 of the battery module 1 are stacked on one another. In addition, one side of the flow path 11 is sealed by a side panel 19 provided in the battery module 1, and the other side of the flow path 11 is connected to a blower 23 through a blower duct 21.

In addition, a module duct 27 is provided on the other side of the battery module 1 and configured to distribute the air introduced into an air inlet 25 to the battery cells 17 constituting the battery module 1.

Accordingly, when the blower 23 operates, the air introduced into the air inlet 25 is distributed through the module duct 27 to cool each of the battery cells 17 of the battery module 1. The air passing through the battery cells 17 flows through the flow path 11 between the flow path forming part 15 and the battery module 1, and the air is discharged through the blower 23, which makes it possible to secure excellent cooling performance of the battery module 1.

In one embodiment, the air inlet 25 is installed to communicate with the lower side of the interior of the vehicle so that the battery module 1 can be cooled with the air inside the vehicle, and an air outlet 29 of the blower 23 is also installed to communicate with the lower side of the interior of the vehicle so that the possibility of a moisture inflow of the battery module 1 through inflow and outflow of the air can be reduced or excluded.

In order to secure airtightness of the flow path 11, sealing members 31 are provided on both sides of the flow path forming part 15 of the mounting plate 7 that are in contact with the battery module 1, and also provided on a portion of the flow path forming part 15 that is in contact with the side panel 19 of the battery module 1.

The sealing member 31 may be made of a compressible material, which can be compressed by pressure applied to fix the battery module 1 to the mounting plate 7 and seal a gap between the battery module 1 and the mounting plate 7. In one embodiment, the compressible material may include felt, rubber, or the like.

For reference, in the cross-sectional view of the present disclosure, the sealing member 31 is illustrated in a shape of overlapping the configuration of the battery module 1 in consideration of compressibility.

In the present embodiment, the mounting plate 7 includes the flow path forming part 15 disposed in the center thereof, and one side of the flow path forming part 15 is bent in the same direction as a wall surface of the first case 3 and is in close contact with and fixed to the wall surface of the first case 3.

Accordingly, the mounting plate 7 may be more firmly fixed to the first case 3, and more great support rigidity for supporting the battery module 1 may be secured.

In one embodiment of the present disclosure, the battery module mounting structure for a vehicle includes: the battery module 1 including the plurality of battery cells 17 stacked in a row; the first case 3 disposed on one side of the battery module 1 and configured to accommodate the battery module 1; and the mounting plate 7 configured to fix the battery module 1 to the first case 3 while surrounding a surface facing the battery module 1 toward the first case 3.

The module duct 27 including the air inlet 25 may be provided on the other side of the battery module 1, and the flow path 11 may be formed between the mounting plate 7 and the battery module 1 such that the air is introduced into the air inlet 25 and passes between the battery cells 17 through the module duct 27 and then can further flow through the flow path 11.

The flow path 11 may be elongated along the stacking direction of the battery cells 17 of the battery module 1, and the mounting plate 7 may include the flow path forming part 15 bent and configured to form a space that defines the flow path 11 between the battery module 1 and the mounting plate 7.

One side of the flow path 11 may be sealed by the side panel 19 protruding to one side of the battery module 1, and the other side of the flow path 11 may be connected to the blower 23 through the blower duct 21.

The sealing members 31 may be disposed between the battery module 1 and the mounting plate 7 and configured to secure the airtightness of the flow path 11 by the pressure at which the battery module 1 is fastened to the mounting plate 7.

The sealing members 31 may be disposed, in a state of being connected to each other, on both sides of the flow path forming part 15 of the mounting plate 7 that are in contact with the battery module 1, and the sealing members 31 may be also disposed at a portion of the flow path forming part 15 that is in contact with the side panel 19 of the battery module 1.

In a cross section perpendicular to the stacking direction of the battery cells 17 of the battery module 1, a central portion of the mounting plate 7 may protrude toward the first case 3 by the flow path forming part 15 and be coupled to the first case 3, and one side of the mounting plate 7 based on the flow path forming part 15 may be bent in the same direction as the wall surface of the first case 3 and be fixed in a state of closely contacting the wall surface of the first case 3.

The second case 5 may be coupled to the other side of the battery module 1, and the second case is coupled to the first case 3 and configured to accommodate the battery module 1 therein. In addition, the air inlet 25 of the module duct 27 and the air outlet 29 of the blower are formed through the second case 5.

Although specific embodiments of the present disclosure have been illustrated and described, it should be apparent to those having ordinary skill in the art that the present disclosure may be variously modified and changed without departing from the technical spirit of the present disclosure.

What is claimed is:

1. A battery module mounting structure for a vehicle, the battery module mounting structure comprising:
a first case configured to surround a first side of a battery module;
a second case coupled to the first case and configured to surround a second side of the battery module so that the battery module is accommodated in an inner space defined by the first case and the second case; and
a mounting plate positioned between the battery module and the first case and coupled to the first case, the battery module configured to be fixed to the mounting plate.

2. The battery module mounting structure of claim 1,
wherein the mounting plate is configured to surround a projection surface of the battery module vertically projected toward the first case.

3. The battery module mounting structure of claim 1,
wherein a plurality of mounting bolts for fixing the battery module is provided on the mounting plate and configured to protrude toward the battery module.

4. The battery module mounting structure of claim 1,
wherein the mounting plate is bent to form a flow path of air passing through the battery module between the mounting plate and the battery module.

5. The battery module mounting structure of claim 4,
wherein the mounting plate includes a flow path forming part which is bent and spaced apart from the battery module, the flow path forming part configured to form the flow path between the mounting plate and the battery module, and
wherein the flow path forming part is fixed to the first case.

6. The battery module mounting structure of claim 5,
wherein the mounting plate has a portion disposed on an upper side of the flow path forming part, spaced apart upwardly from the first case, and configured to support the battery module, and
wherein in the portion of the mounting plate spaced apart upwardly from the first case, a plurality of mounting bolts pass through only the mounting plate and battery module.

7. The battery module mounting structure of claim 5,
wherein the flow path forming part of the mounting plate is elongated and configured to form the flow path along a direction in which battery cells of the battery module are stacked on one another,
wherein a first side of the flow path is sealed by a side panel provided in the battery module, and
wherein a second side of the flow path is connected to a blower through a blower duct.

8. The battery module mounting structure of claim 7,
wherein a module duct is disposed on the second side of the battery module and configured to distribute the air introduced into an air inlet to the battery cells that constitute the battery module.

9. The battery module mounting structure of claim 7,
wherein sealing members are disposed on both sides of the flow path forming part of the mounting plate that are in contact with the battery module, and a portion thereof that is in contact with the side panel of the battery module, and configured to secure airtightness of the flow path.

10. The battery module mounting structure of claim 7,
wherein the flow path forming part is provided at a center of the mounting plate, and
wherein one side of the flow path forming part is bent in the same direction as a wall surface of the first case and fixed in a state of closely contacting the wall surface of the first case.

11. A battery module mounting structure for a vehicle, the battery module mounting structure comprising:
a battery module including a plurality of battery cells stacked in a row;
a first case disposed on a first side of the battery module and configured to accommodate the battery module; and
a mounting plate configured to fix the battery module to the first case while surrounding a surface facing the battery module toward the first case.

12. The battery module mounting structure of claim 11,
wherein a module duct having an air inlet is provided on a second side of the battery module, and
wherein a flow path through which air introduced into the air inlet and passed between the battery cells through the module duct flows is formed between the mounting plate and the battery module.

13. The battery module mounting structure of claim 12,
wherein the flow path is elongated along a battery cell stacking direction of the battery module, and
wherein the mounting plate includes a flow path forming part bent and configured to form a space that defines the flow path between the mounting plate and the battery module.

14. The battery module mounting structure of claim 13,
wherein a first side of the flow path is sealed by a side panel protruding to one side of the battery module, and
wherein a second side of the flow path is connected to a blower through a blower duct.

15. The battery module mounting structure of claim 14,
wherein sealing members are disposed between the battery module and the mounting plate and configured to secure airtightness of the flow path by pressure at which the battery module is fastened to the mounting plate.

16. The battery module mounting structure of claim 15,
wherein the sealing members are disposed, in a state of being connected to each other, on both sides of the flow path forming part of the mounting plate that are in contact with the battery module, and at a portion thereof that is in contact with the side panel of the battery module.

17. The battery module mounting structure of claim 14,
wherein in a cross section perpendicular to the battery cell stacking direction of the battery module,
a central portion of the mounting plate protrudes toward the first case by the flow path forming part and is coupled to the first case, and
wherein one side of the mounting plate based on the flow path forming part is bent in the same direction as a wall surface of the first case and fixed in a state of closely contacting the wall surface of the first case.

18. The battery module mounting structure of claim 14,
wherein a second case is coupled to the second side of the battery module, the second case being coupled to the first case, configured to accommodate the battery module therein, and through which an air inlet of the module duct and an air outlet of the blower are formed.
